(19) United States
(12) Patent Application Publication
(10) Pub. No.: US 2020/0047760 A1
(43) Pub. Date: Feb. 13, 2020

(54) METHOD FOR OPERATING A HYDRAULIC BRAKE SYSTEM OF A MOTOR VEHICLE

(71) Applicant: Ford Global Technologies, LLC, Dearborn, MI (US)

(72) Inventor: Thomas Svensson, Leichlingen (DE)

(73) Assignee: Ford Global Technologies, LLC, Dearborn, MI (US)

(21) Appl. No.: 16/534,238

(22) Filed: Aug. 7, 2019

(30) Foreign Application Priority Data
Aug. 9, 2018 (DE) 102018213436.7

(51) Int. Cl. B60W 30/18; B60T 13/14; B60T 17/22; B60W 10/18; B60W 10/00; B60T 7/12; B60T 8/17

(52) U.S. Cl. CPC B60W 30/18109; B60T 13/14; B60T 17/221; B60W 10/182; B60W 10/00; B60T 2270/402; B60T 8/17; B60W 2510/182; B60W 2710/18; B60W 2720/10; B60T 7/12

(57) ABSTRACT

The disclosure relates to a method for operating a hydraulic brake system of a motor vehicle. The method comprises recording a value that is representative of a transfer function of the brake system, and comparing the recorded value with a threshold value. The method further comprises generating an error signal if the recorded value exceeds the threshold value. The value may be indicative of a brake pressure, a brake pressure request signal and a decreasing acceleration of the motor vehicle.

### CROSS-REFERENCE TO FOREIGN PRIORITY APPLICATION

The present application claims the benefit under 35 U.S.C. § 119 of DE 102018213436.7 filed Aug. 9, 2018, the disclosure of which is incorporated herein by reference.

### FIELD OF THE INVENTION

The present disclosure generally relates to a method for operating a hydraulic brake system of a motor vehicle.

### BACKGROUND OF THE INVENTION

Motor vehicles with an electric or hybrid drive are usually designed for the recuperation of braking energy. Motor vehicles with an electric or hybrid drive typically conduct the braking energy for intermediate storage in accumulators. However, in a motor vehicle that is designed for the recuperation of braking energy, a service brake (also called service brake system—SBS) generally cannot be configured with smaller dimensions in order to also ensure a functionality of the service brake when a boiling point of the brake fluid is exceeded during operation and bubbles begin to form in the brake fluid.

### SUMMARY OF THE INVENTION

The transfer function of the brake system links at least one input variable of the brake system with an output variable of the brake system, such as a decreasing acceleration of the motor vehicle. By continuously monitoring the transfer function, it is possible to record changes in parameters of the transfer function that can be traced back to, for example, a degeneration of brake fluid as a result of water absorption. If deviations exceed a predetermined threshold, an error signal is generated. Information is thus made available about a decreasing functionality of the service brake so that countermeasures can be introduced. For example, functionality of the brake system can be prolonged, which permits the service brake to be dimensioned smaller.

According to one embodiment, a brake pressure and/or a brake pressure request signal and/or a decreasing acceleration of the motor vehicle are recorded as the value that is representative of the transfer function of the brake system. For instance, brake pressure can be a force with which a brake pedal of the motor vehicle is actuated. In addition to brake pressure, other dynamic values may be considered, such as an actuation speed and/or actuation acceleration of the brake pedal. In other words, how quickly an actuation of the brake pedal leads to a decreasing acceleration of the motor vehicle is additionally or alternatively recorded and evaluated. Furthermore, brake request signals, such as those that activate electrohydraulic brakes, or a decreasing acceleration of the motor vehicle can be used.

According to a further embodiment, a driver information signal is generated in response to the error signal. This results in an item of visual and/or acoustic information for a driver about a degeneration of the brake fluid, whereupon a change of brake fluid can be undertaken.

According to a further embodiment, a vehicle limit signal is generated in response to the error signal. The vehicle limit signal limits a maximum velocity of the motor vehicle to a value that, despite the degeneration of the brake fluid, maintains operation of the motor vehicle 2.

According to a further embodiment, a parking brake activation signal is generated in response to the error signal. The parking brake activation signal activates a parking brake, which effectuates a decreasing acceleration of the motor vehicle using an additional braking force. With a parking brake (also called emergency brake system—EBS), the motor vehicle can be parked long-term without inadvertently rolling away. The parking brake can be configured as an electromechanical emergency brake (also called an electric park brake—EPB), which is actuated by means of a button in an instrument panel or a center console. The parking brake functions independently of a service brake so that, in an emergency situation, emergency braking to a complete stop can be performed by an activation of the parking brake activation signal.

According to a further embodiment, brake fluid is taken from a brake fluid reservoir and added to the brake system if there is no brake force request and/or when the motor vehicle is at a complete stop with a motor vehicle velocity of zero. In this way, a percentage of water in brake fluid can be reduced by addition of brake fluid that is free of water, and a boiling point of the brake fluid can thereby be increased. Multiple sub-steps can be carried out for this purpose. For example, an ABS (“Automatic Brake System”) outlet valve of an ABS system of the motor vehicle can be opened, and cold brake fluid can be added to the brake system. This can take place gradually in multiple iterations until the recorded value is below the threshold value again.

The disclosure further relates to a computer program product, a controller, and a motor vehicle having a controller of this type.

The disclosure will now be explained on the basis of an illustration.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a schematic representation of a brake system of a motor vehicle; and

FIG. 2 is a schematic representation of a process sequence for operating the brake system shown in FIG. 1.

### DETAILED DESCRIPTION OF THE PREFERRED EMBODIMENTS

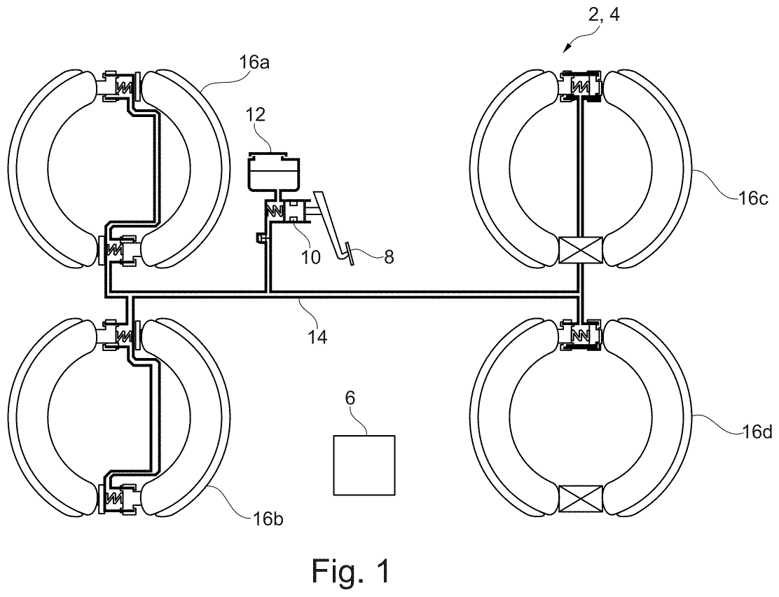

Reference is made initially to FIG. 1.

FIG. 1 shows a brake system 4 of a motor vehicle 2, such as a passenger car.

In the present exemplary embodiment, the brake system 4 is a hydraulic brake system 4 and is configured to slow down the motor vehicle 2 and bring it to a complete stop during normal operation.

The brake system 4 can also be considered a service brake system (SBS) of the motor vehicle 2, which can be actuated progressively and acts upon all wheels of the motor vehicle 2.

Regarding components of the brake system 4, FIG. 1 shows the brake system 4 having a controller 6, a brake pedal 8, a brake booster 10, a brake fluid reservoir 12, a brake line 14, and disc brakes 16a, 16b, 16c, 16d that are associated with each wheel of the motor vehicle 2.

The brake system 4 can be configured as a single- or dual-circuit system. Furthermore, the brake system 4 can have the functionality of an ABS (“Automatic Brake System”) system.

The brake system 4 is actuated by a driver of the motor vehicle 2 using the brake pedal 8. A brake pressure applied in this way is enhanced by the brake booster 10 and is distributed evenly through the brake line 14 to the disc brakes 16a, 16b, 16c, 16d.

Moreover, the motor vehicle 2 has a parking brake (not shown), with which the motor vehicle 2 can be parked long-term without inadvertently rolling away. The parking brake can also be considered an emergency brake system (EBS) of the motor vehicle 2. In the present exemplary embodiment, the parking brake is configured as an electromechanical parking brake (EPB).

The brake system 4 uses brake fluid as a hydraulic fluid, which tends to absorb water as a result to its hygroscopic properties. If the brake fluid heats up during operation, the absorbed water can begin to boil, and so vapor bubbles form in the brake fluid. In contrast to the brake fluid, these vapor bubbles are easily compressible with the effect that the brake fluid loses its properties as a hydraulic fluid, and an actuation of the brake pedal 8 no longer or only partly results in an actuation of the disc brakes 16a, 16b, 16c, 16d.

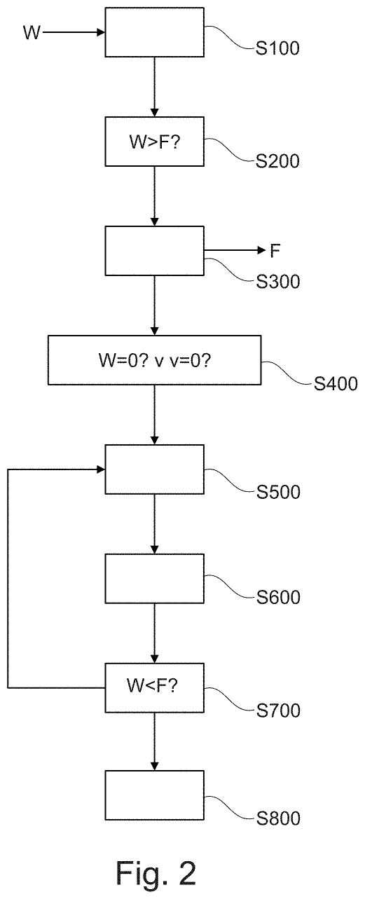

To counteract this, the brake system 4 is operated by a method that will now be explained with additional reference to FIG. 2.

The controller 6 may be a dedicated brake controller 6 or a shared controller 6. The controller 6 may be a microprocessor or any other analog and/or digital circuitry. The controller 6 may include a memory and be programmed to follow a brake control routine. During operation, the controller 6, which can have hardware and/or software components for these and the subsequently described tasks and/or functions, records a value W that is representative of a transfer function of the brake system 4 in a first step S100. As will be described in more detail below, the controller records a brake pressure request signal as a value representative of a transfer function of the brake system to compare the value with a threshold value, and generates an error signal if the value exceeds the threshold value. The controller 6 may also record a brake pressure or a decreasing acceleration of the motor vehicle as the value that is representative of the transfer function of the brake system.

In the present exemplary embodiment, the value W is a brake pressure generated with the brake pedal 8. Instead of the brake pressure generated by actuating the brake pedal 8, a brake pressure request signal can also be recorded and evaluated if the motor vehicle 2 has, for example, an electrical brake pedal 8 of an electrohydraulic brake, or a decreasing acceleration of the motor vehicle 2 is detected.

In a further step S200, the controller 6 compares the recorded value W with a predetermined threshold value G. In the present exemplary embodiment, the threshold value G is a brake pressure that is representative of a decreasing acceleration of the motor vehicle 2 from, e.g., 2.44 m/s2 or 6.4 m/s2 at a pedal force of 500 N as an input brake pressure. The value W is then representative, e.g., of an output brake pressure, which is applied to the disc brakes 16a, 16b, 16c, 16d. Alternatively, or additionally, it is possible to detect the brake pressure request signal on the input side, for example, and/or to detect the decreasing acceleration of the motor vehicle 2 on the output side, for example.

In a further step S300, the controller 6 generates an error signal F if the recorded value W exceeds the threshold value G. In other words, owing to a degeneration of the brake fluid in this instance, the brake system 4 has insufficient braking power, which lies below the decreasing acceleration of the motor vehicle 2 of, e.g., 2.44 m/s2 or 6.4 m/s2 at 500 N pedal force.

In response to the error signal F, a driver information signal and/or a vehicle limit signal and/or a parking brake activation signal is generated.

The driver information signal results in an item of visual and/or acoustic information for the driver about the degeneration of the brake fluid, whereupon a change of brake fluid can be undertaken. The vehicle limit signal limits a maximum velocity of the motor vehicle 2 to a value that, despite the degeneration of the brake fluid, maintains operation of the motor vehicle 2 with the existing maximum decreasing acceleration of the motor vehicle 2. The parking brake activation signal activates the parking brake, which effectuates a decreasing acceleration of the motor vehicle 2 with additional braking force.

In a further step S400, the controller 6 verifies whether there is no brake force request (logical variable B=0) and/or whether the motor vehicle 2 is at a stop with a motor vehicle velocity v of zero (logical variable v=0).

If one of these two conditions, being a no brake force request or the motor vehicle 2 being at a stop, is satisfied (B=0 or v=0), then, for the rest of the process, brake fluid is taken from the brake fluid reservoir 12 and added to the brake system 4.

Alternatively to the present exemplary embodiment, it is also possible to remove brake fluid from the brake fluid reservoir 12 and add brake fluid to the brake system 4 when the motor vehicle 2 is located on an incline if a predetermined duration, or as long as a measured or simulated brake temperature, is above a threshold value.

To this end, an ABS (“Automatic Braking System”) outlet valve (not shown) is opened in a further step S500.

In a further step S600, a predetermined amount of cold brake fluid is removed from the brake fluid reservoir 12 and added to the brake system 4.

In a further step S700, the controller 6 verifies whether a newly recorded value W still exceeds the predetermined threshold value G.

If the newly recorded value W exceeds the predetermined threshold value G, the method is repeated, beginning at step S400. In other words, steps S400 through S700 are performed multiple times until the respective newly recorded value W no longer exceeds the predetermined threshold value G.

On the other hand, if the newly recorded value W no longer exceeds the predetermined threshold value G, the method is concluded at a step S800, and the motor vehicle 2 with the brake system 4 can resume being operated normally.

In this way, the functionality of the brake system 4 can be prolonged, which permits the service brake to be dimensioned smaller.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for operating a hydraulic brake system of a motor vehicle, comprising:
recording a brake pressure as a recorded value that is representative of a transfer function of the brake system;
comparing the recorded value with a threshold value; and
generating an error signal if the recorded value exceeds the threshold value.

2. The method as claimed in claim 1 further comprising recording a brake pressure request signal of the motor vehicle as the value that is representative of the transfer function of the brake system.

3. The method as claimed in claim 1 further comprising generating an informative signal directed at a driver in response to the error signal.

4. The method as claimed in claim 1 further comprising generating a vehicle limit signal in response to the error signal.

5. The method as claimed in claim 1 further comprising generating a parking brake activation signal in response to the error signal.

6. The method as claimed in claim 1 further comprising taking brake fluid from a brake fluid reservoir and adding the brake fluid to the brake system if there is no brake force request and when the motor vehicle is at a complete stop having a velocity of zero.

7. A brake system for a vehicle comprising:
a controller that operates the brake system of the vehicle, wherein the controller records a brake pressure request signal as a value representative of a transfer function of the brake system to compare the value with a threshold value, and generates an error signal if the value exceeds the threshold value.

8. The brake system as claimed in claim 7, wherein the controller records a brake pressure of the motor vehicle as the value that is representative of the transfer function of the brake system.

9. The brake system as claimed in claim 7, wherein the controller generates a driver information signal in response to the error signal.

10. The brake system as claimed in claim 7, wherein the controller generates a vehicle limit signal in response to the error signal.

11. The brake system as claimed in claim 7, wherein the controller generates a parking brake activation signal in response to the error signal.

12. The brake system as claimed in claim 7, wherein the controller transfers brake fluid from a brake fluid reservoir to the brake system if there is no brake force request or if a velocity of the motor vehicle is zero such that the vehicle is at a complete stop.

13. A motor vehicle comprising:
a brake system having a transfer function representative of a decreasing acceleration of the motor vehicle; and
a brake controller that records the decreasing acceleration of the motor vehicle as a value indicative of the transfer function and compares the value to a threshold such that an error signal is generated if the value exceeds the threshold.

14. The motor vehicle as claimed in claim 13, wherein the controller generates a driver information signal in response to the error signal.

15. The motor vehicle as claimed in claim 13, wherein the controller generates a vehicle limit signal indicative of a maximum velocity of the motor vehicle in response to the error signal, wherein the maximum velocity is limited to a pre-determined value.

16. The motor vehicle as claimed in claim 13, wherein the controller generates a parking brake activation signal in response to the error signal.

17. The motor vehicle as claimed in claim 13, wherein the controller transfers brake fluid from a brake fluid reservoir to the brake system if there is no brake force request and if a velocity of the motor vehicle is zero.

18. The motor vehicle as claimed in claim 13, wherein the controller records a brake pressure as the value that is representative of the transfer function of the brake system.
